(19) United States
(12) Patent Application Publication
(10) Pub. No.: US 2025/0278801 A1
(43) Pub. Date: Sep. 4, 2025

(54) SMART SOLAR SYSTEM AND METHOD FOR MONITORING

(71) Applicants: Justin Evans, Washington, DC (US); Ian Evans, Takoma Park, MD (US)

(72) Inventors: Justin Evans, Washington, DC (US); Ian Evans, Takoma Park, MD (US)

(21) Appl. No.: 19/068,787

(22) Filed: Mar. 3, 2025

Related U.S. Application Data
(60) Provisional application No. 63/560,414, filed on Mar. 1, 2024.

(51) Int. Cl. G06Q 50/06; G06Q 30/0207; G06Q 30/04

(52) U.S. Cl. CPC G06Q 50/06; G06Q 30/0207; G06Q 30/04

(57) ABSTRACT

Systems, methods, and other embodiments associated with collection and monitoring of utility (e.g., electricity and solar power) consumption, generation, and usage from these various sources are described. In one embodiment, a method includes acquiring a discount rate for a utility electric service, determining a market rate based on a tier of the utility electric service, calculating a net energy metering (NEM) credit, the NEM credit being determined based on the excess electricity produced, determining at least one of an electrical generation system or an electrical storage system, calculating electricity generated from the electrical generation system or the electrical storage system, determining actual solar energy consumption by comparing inverter production data with real-time usage information from a utility account or on-premise meter, and generating and displaying, via a graphical user interface (GUI), the NEM credit along with the actual solar energy usage and the electricity generated for a predetermined period.

### CROSS-REFERENCE TO RELATED APPLICATIONS

The present application claims priority to U.S. Provisional Patent Application No. 63/560,414 filed Mar. 1, 2024, titled “SMART SOLAR SYSTEM AND METHOD FOR MONITORING UTILITY CONSUMPTION AND GENERATION,” hereby incorporated by reference in its entirety.

### TECHNICAL FIELD

The embodiments generally relate to systems and methods for monitoring, calculating, and optimizing solar energy consumption. Introducing an algorithm for accurately determining an end-user's actual solar energy consumption by integrating inverter production data with real-time utility usage data, on-premise meters, and optional Current Transformers (CTs). The system enables precise energy billing, optimized solar resource allocation, and enhanced savings calculations for landlords, tenants, and homeowners.

### BACKGROUND

The traditional approach to solar energy billing and monitoring has primarily focused on measuring solar energy production rather than actual solar energy consumption by end users. Existing utility tracking systems often lack the capability to differentiate between energy generated by a solar power system and the portion that is directly consumed by tenants, homeowners, or property managers. This limitation creates inefficiencies in solar billing, savings calculations, and Power Purchase Agreements (PPAs), as users may be charged based on production rather than their actual energy usage.

Furthermore, current solutions fail to dynamically integrate real-time consumption data from utility accounts, on-premise meters, and additional monitoring tools such as Current Transformers (CTs). This results in inaccurate financial transactions, missed savings opportunities, and difficulties in fairly allocating solar energy in rental or multi-tenant environments. There is a need for a precise and automated system that can seamlessly monitor, calculate, and optimize solar energy consumption across various stakeholders while ensuring compliance with market rates and energy policies.

### SUMMARY OF THE INVENTION

This brief overview provides a high-level summary of the invention, introducing key concepts that may be further detailed below. This summary is not intended to define essential features or limit the scope of the claimed subject matter.

The disclosed system and method enable precise monitoring, calculation, and optimization of solar energy consumption through a novel algorithm that differentiates between total solar energy production and actual end-user consumption. By integrating data from solar inverters, utility accounts, and optional real-time monitoring devices such as Current Transformers (CTs), the system ensures accurate financial transactions and energy resource allocation.

Unlike conventional solar monitoring solutions that primarily track energy production, this system facilitates dynamic and usage-based billing models. It supports multiple applications, including landlord-tenant billing, solar savings calculator, and a novel Power Purchase Agreement (PPA) model that bases charges on actual solar energy consumption rather than production.

The system enables landlords to bill tenants accurately for their direct solar energy usage at a discounted rate, ensuring compliance with energy regulations. Additionally, homeowners can utilize the solar savings calculator to quantify financial savings from solar energy usage in real-time based on utility market rates.

The usage-based PPA model introduces a new approach to solar financing by charging users based on the energy they actually consume rather than the total energy generated by their solar system or an external solar facility. This ensures fairer and more cost-effective energy billing, particularly in cases where production and consumption levels do not align perfectly.

By leveraging an integrated approach that combines real-time energy tracking, dynamic billing structures, and precise savings calculations, the invention enhances transparency, maximizes financial benefits for users, and optimizes the use of solar energy across different customer segments.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale. A complete understanding of the present embodiments and the advantages and features thereof will be more readily understood by reference to the following detailed description when considered in conjunction with the accompanying drawings wherein:

FIG. 1 illustrates one embodiment of a utility generation and consumption system, including a client computing device, solar inverter, utility company interface, and software components for monitoring and managing energy usage;

FIG. 2 illustrates one embodiment of a method performed by the system of FIG. 1 for monitoring utility consumption through example sources, acquiring data from solar inverters and utility accounts, and calculating solar energy usage for accurate billing and savings assessment;

FIG. 3 illustrates an embodiment of a computing system configured with the disclosed methods, including processing components, memory storage, software interfaces, and user interface elements for displaying real-time energy consumption and financial calculations;

FIG. 4 illustrates a detailed breakdown of the landlord-tenant solar billing system, demonstrating how solar energy consumption is monitored per tenant, net metering credits are allocated, and financial transactions are processed based on the calculated discount rate.

FIG. 5 illustrates the architecture of the usage-based Power Purchase Agreement (PPA) model, highlighting the integration of inverter data, utility account tracking, and dynamic pricing adjustments to bill users based on actual solar energy consumption rather than production.

### DETAILED DESCRIPTION

Systems, devices, and methods are described herein as associated with collecting and monitoring utility generation, usage, and consumption, in one embodiment. As an example, solar power systems may be used by users or landlords who can generate income from them by (1) selling the electricity that the solar power system generates to their tenants at a discount relative to market prices, and (2) selling the Solar Renewable Energy Credits (SRECs) that their systems produce in qualifying markets. For example, in selling utilities to other users, landlords need to be assured that they stay in compliance with the law, and/or out of the way of potential legal action. That is, landlords need to ensure that tenants are charged less than or equal to market rates (i.e. what the tenant could've purchased their electricity for from their utility company.) And the only way to do that is to measure exactly how much electricity the tenant is actually consuming from the solar power system each month and year. However, calculating how much of solar-generated electricity is actually used each month is not intuitive. For the legal compliance in selling generated utility (e.g., solar power), landlords need to measure exactly how and how much solar-generated electricity is used, consumed, and generated.

Software and Application Programming Interface (API) solutions may be used as one means to solve this problem. The software and API solutions may, for example, calculate the usage of solar-generated electricity using one or more functions, programs, or algorithms. Any excess power produced can be (A) stored in a battery storage system, or (B) sent back to the utility company in exchange for credits that can be used in future months via a process called “Net Energy Metering.” (“Net Metering” or simply “NEM,” for short). If a Net Metering credit balance has been accumulated by the customer, those net metering credits can be used during wintertime to pay for some or all of the electricity purchased from the utility company. For example, California used to offer 1:1 net metering (NEM Ratio 1:1) but has recently transitioned to 6:1 ratio (“NEM 3.0.”), for every 6 kWh of solar electricity surplus production sent back to the grid, California utility companies offer only 1 kWh of net metering credits for customers to use on future bills. To get the same 1:1 net metering benefit that buyers of solar were accustomed to, California residents must now purchase a battery, or series of batteries, costing them thousands of dollars.

The software and API may provide solar usage calculation that includes calculating a tenant's solar usage broken down into three parts: “Solar Production and Coverage” (S) that includes measuring how much of a tenant's total electricity usage during a given month was covered by solar power production during that same month, “NEM Credit Usage” (NEM) that includes usage of NEM credits from any existing NEM credit balance (which were accumulated via excess system production during prior months) to cover any consumption surplus, and “Self-consumption,” (SC) which is a measure of electricity that was consumed during daylight hours and is often not measured by a property's electric meter (since the power is consumed directly from the system during the daylight hours that the solar power system is actively producing electricity). The “Total Usage” (TU) the solar power system reports the total output from solar power on its own that is TU=S+NEM+SC. The software and API solution may further include usage calculation that also encompasses use cases where a property owner has purchased a battery for the property.

The software and API solution may fetch the data through various sources. For example, the data pull may include use of a “Utility API” that includes a utility data service used to request and download utility customer bill and interval data. This data could also be supplied by a different data provider. The data could also be supplied by a utility company directly. The data could also be requested directly from the customer via software and API solution. Further, the data may be collected through an independent electric meter (separate and distinct from the electric meter that comes standard on a residential home) and may be installed by an electrician at the property that could measure and report this data as well. Further, the solar inverter(s) may report data from the solar power system installed and/or located at the customer's property. The battery storage system, if installed and/or located at the customer's property, corresponds with and stores electricity generated by the customer's solar power system. The software and API solution may access one or more databases that includes certain pieces of data provided by the other three data sources mentioned above that may be manipulated by our software, and the corresponding outputs are used in our calculation of total solar usage.

Moreover, Solar Renewable Energy Credits (SRECs) can provide a key component of a landlord's income from his or her solar power system in qualifying markets. As such, we plan to offer services pertaining to the brokerage and liquidation of SREC credits in the future, similar to the services performed by a third-party firm that we currently outsource this function to called “SREC Trade.” Since software and API solution can have all of the necessary data which, for the purposes of SREC programs and reporting, may include annual solar production already available, the software and API solution may provide these services to customers directly rather than outsourcing them to a third party (SREC Trade) once we have a sufficient number of customers. (SRECs are sold in bulk by the hundreds or thousands, so scale is key in order for us to be able to add this to our service offering).

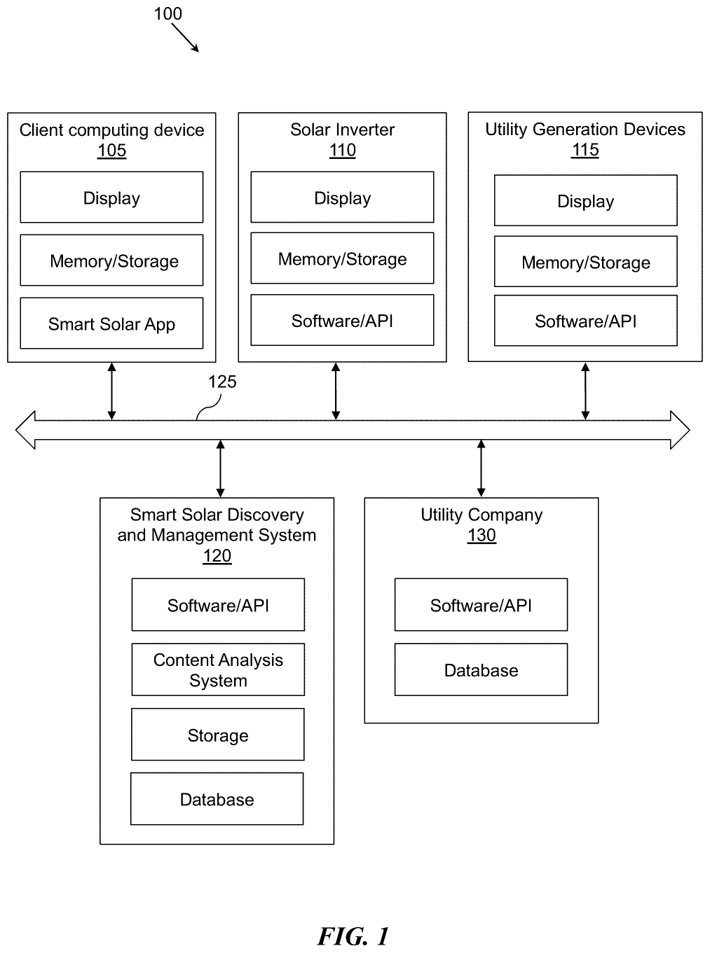

Referring to FIG. 1, a client computing device 105 may be installed with a utility application, for example, a smart solar application that accesses utility company account, databases, or systems to collect utility usage. Further, the smart solar application may obtain access to a user's solar panel system(s) and power generation system(s) to collect utility usage and generation information. The utility collection and monitoring system 100 may include one or more client computing devices 105, solar inverters 110, utility generation devices 115, smart utility discovery and management systems 120, utility companies 130. The client device 105 may access through a network communication channel 125 (e.g., cloud computing system) one or more utility usage monitoring systems, public, private, or proprietary system such as, for example, a solar inverter 110, utility generation devices 115, and utility company usage and rate information for the generated and/or consumed utility (e.g., solar power and electricity usage). The smart solar application of the client device 105 may install and/or access software/API on one or more utility usage monitoring systems, for example, a solar inverter 110, utility generation devices 115, and other systems that may be used to generate, control, and/or monitor utility usage, and the like. The smart solar application may track, record, and display utility consumption, usage, and generation information.

A smart utility discovery and management system 120 may access one or more sources to collect utility consumption, usage, and generation. In one embodiment, the smart utility discovery and management system 120 may access the client device 105, the solar inverter 110, the utility generation device 115, the utility company 130, or any combination thereof, to collect utility generation, consumption, and usage information. In one embodiment, the smart utility discovery and management system 120 may install and/or access software/API on one or more utility usage monitoring systems, for example, the client device 105, the solar inverter 110, the utility generation devices 115, and other systems that may be used to generate, control, and/or monitor utility usage, and the like.

In one embodiment, the client computing device 105 and/or the smart utility discovery and management system 120 may access the utility company 130 database and/or software/API to collect information on utility usage, consumption, and generation. In one embodiment, the client computing device 105 and/or the smart utility discovery and management system 120 may access a user's email, account, or other database to collect and verify usage and generation information, rates (e.g., utility market prices), and market information such as utility credits (e.g., renewal energy credits, net metering credits, etc.), rewards, adjustments, account balances, usage daily, monthly, and annual patterns, total utility consumption, self-consumption, and other information.

The utility company 130 may provide utility consumption, usage, and generation information through a utility statement to the user via a paper mail and/or to the client computing device 105, via a digital copy, that may be accessed or otherwise scanned by the client computing device 105 and/or the smart utility discovery and management system 120 to track and record utility consumption, usage, and generation information.

The solar inverter 110 may install software/API on the user's solar panel systems and utility generation devices to collect utility consumption, usage, and generation information. In one embodiment, the solar inverter 110 may be configured to remotely access a user's generation and/or consumption monitoring systems. The information may then be sent to the client computing device 105 and/or the smart utility discovery and management system 120 to track, record, and display utility consumption, usage, and generation information.

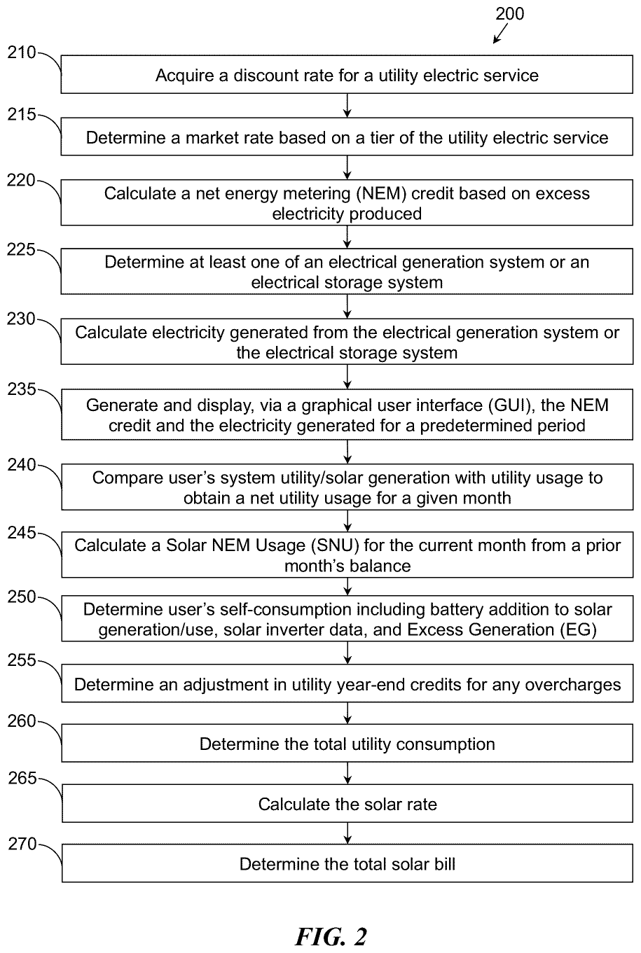

Referring to FIG. 2, one embodiment of a method of monitoring utility consumption through example sources, utility consumption and generation monitoring may be implemented through example software systems and/or hardware systems and devices disclosed. Each block shown in FIG. 2 represents one or more processes, methods or subroutines, carried out in the exemplary method. FIGS. 1 and 3-5 show example embodiments of carrying out the method of FIG. 2 for collecting and monitoring utility consumption, usage, and generation information. The exemplary method may begin at Step 1. Method 200 may be used independently or in combination with other methods or process for collecting and monitoring utility consumption, usage, and generation information. For explanatory purposes, the example process 200 is described herein with reference to the monitoring system 100 of FIG. 1. Further for explanatory purposes, the blocks of the example process 200 are described herein as occurring in serial, or linearly. However, multiple blocks of the example process 200 may occur in parallel. In addition, the blocks of the example process 200 may be performed a different order than the order shown and/or one or more of the blocks of the example process 200 may not be performed. Further, any or all blocks of example process 200 may further be combined and done in parallel, in order, or out of order. In FIG. 2, the exemplary method 200 of implementing a utility collection and monitoring system for collecting and monitoring utility consumption, usage, and generation information. Method 200 begins at Step 1.

In block 210, the discount rate is calculated, the discount rate being a percentage discount from the market rate for using solar generated power. The discount rate may be defined as follows:

Discount Rate (DR)=% Entered by User (landlord).

Where % Entered by User (landlord) is the percentage discount provided by the user or landlord to a tenant for using solar power in a predetermined period of time (e.g., monthly discount rate).

In block 215, the market rate is calculated, the market rate being the cost per kilowatt hour (kW·h) of use in a given usage tier. In some localities and regions, the utility company may charge the user based on usage tiers, where the rates increase based on increase usage during a month. The Market Rate then depends on the dollar ($) amount charged by the utility company in a usage tier for a number (m) of kilowatt hours (kW·h) used in the usage tier, or m×(kW·h). The Market Rate may be defined as follows:

$$Market Rate ( MR ) = \frac{UC}{m \times ( kW \cdot h )} [ \frac{\$ Charge in tier}{\# of kW \cdot h} ] .$$

Where UC is the utility company charge in tier for usage:

Utility Company Charge (UC)=Currency cost in tier of utility usage.

Thus, UC is the dollar cost in tier for utility usage, and m is the amount of utility designated per dollar cost in tier for utility usage, where m may vary (i.e., increase) based on the (i.e., increased) tier of usage. In some embodiments, the utility company may charge a different rate for one or more tiers of usage. As an example, a first tier (tier 1 usage) may be configured as electricity usage for a period of a month corresponding to 0-1000 kW·h of usage in the month. For example, for a customer using 800 kW·h in a given month, the usage tier is tier 1, the utility company charge (UC) may be $0.015 in tier 1, the number (m) of kW·h in the usage tier may be 100. Thus, in tier 1, the Market Rate (MR)=$0.015/100 kW·h. As another example, a second tier (tier 2 usage) may be configured as $0.017 for 1001-2000 kW·h of usage in the month per 120 kW·h of usage in tier 2, where in tier 2, UC=$0.017, and m=120. In tier 2, the Market Rate (MR)=$0.017/120 kW·h.

In block 220, the method may further include calculating the Net Energy Metering (NEM), that is excess power produced by a user through, for example, a solar panel system, that the utility company credits to the user that can be used at a later time or sold back to the utility company or another utility company for discount or credits that can be used in future months via a process called Net Energy Metering. The utility company may buyback excess generated utility (CP) and provide the user with compensation defined as:

$$Utility Buyback Compensation ( CP ) = \frac{\$ Compensation}{kW \cdot h} .$$

The user compensation depends on the excess generated utility NEM and the NEM ratio defined by the utility company based on various factors such as climate, location, amount of sunlight, city or government finances and ordinances, energy needs, and the like. The calculation for NEM may include determining the NEM Ratio that determines the credit amount or ratio in energy provided to the user. In some embodiments, the excess generated utility generated by the user may be credited back to the user at the same rate (e.g., 1:1), for example, NEM Ratio=1, where 1 unit of excess generated utility is credit back at the same 1 unit to the user. In other words, if the NEM credit is unity the power/utility generated equals the same power/utility credited, if the NEM credit is other than unity, the ratio of compensation dollars and market rate are used to determine the user's energy credit for future use. The NEM Ratio may be defined as follows:

$$NEM Ratio = \{ \begin{matrix}\frac{CP}{Market Rate} , CP \neq Market Rate \\ 1 , CP = Market Rate\end{matrix} .$$

As an example, the utility company may compensate or credit a user for excess power/utility generated at a rate of $0.167/kW·h and charge the user for power/utility consumed at $1.000/kW·h. Thus, NEM

$$Ratio = \frac{CP}{MR} = \frac{\$ 0.167 / kW \cdot h}{\$ 1. / kW \cdot h} = \frac{1}{6} .$$

In block 225, the method includes determining whether the user has a utility generation or storage system (e.g., generated electricity), for example, a battery addition to the utility/solar power system, and further calculating battery additions occurring daily during a predetermined period (e.g., monthly billing cycle). If the user system includes a battery for storing generated solar/utility, the Battery Additions (BA) to user consumption/generation calculation may be defined as follows:

Battery Additions (BA)=ΣBattery daily additions in the month.

In block 230, the method may further calculate Total Battery Usage (TBU) as the sum of daily subtractions from the battery in a given month. In some embodiments, any electrical storage system may be used. When in use the electrical storage system may provide/generate electricity and the usage of which is measured. The Total Battery Usage (TBU) may be defined as follows:

Total Battery Usage (TBU)=ΣBattery daily subtractions in the month.

In block 235, the client computing device 105, solar Inverter 110, smart solar discovery and management system 120, or any combination thereof may generate and display, via a graphical user interface (GUI), the NEM credit and the electricity generated for a predetermined period as well as any measured, calculated, determined, acquired or computed data or information in blocks 210-270.

In block 240, the method may further compare the user's system utility/solar generation with utility usage to obtain a net utility usage for a given month. From the net utility usage in a given month, the amount of solar NEM credits generated and used may be determined. In one embodiment, a user's Excess Generation (EG) of utility/solar power and Current Month Usage (CMU) of utility/solar power are used to determine the Solar NEM Usage (SNU) for a given month.
Solar NEM Usage_{Current Month}(SNU) [kW·h].
Excess Generation_{Current Month} (EG) [kW·h].
Current Month Usage (CMU) [kW·h].

$${SNU}_{Current Month} = \{ \begin{matrix}CMU \times NEM Ratio , EG \geq CMU , for current month \\ EG \times NEM Ratio , EG < CMU , for current month\end{matrix} .$$

In determining SNU for the current month, two conditions may apply, either the user's Excess Generation (EG) of utility/solar power is equal to, or greater than, their Current Month Usage (CMU) of utility/solar power, or the user's Excess Generation (EG) of utility/solar power is less than their Current Month Usage (CMU) of utility/solar power.

In the first case, EG≥CMU, the Solar NEM Usage (SNU) for the given month is equal to CMU×NEM Ratio. In this scenario, the system produced more utility/power than that used by the user, and the user needs to pay for utility/solar generated (i.e., utility/solar generated was all covered by what the system produced). Moreover, this scenario includes an edge case where the system produced 0 kW·h, for example, where the user utility/power consumption is the same amount generated by the system (e.g., the user was out of town).

In the second case, EG<CMU, the Solar NEM Usage (SNU) for the given month is equal to EG×NEM Ratio. In this scenario the system produced less than what the user used, and the user may be charged for the power/utility that the system produced, because the generated utility/power was credited to the user and the power/utility used from the utility company. In this scenario, the user's NEM credits from a prior month are assessed to determine the amount charged to the user as will be described below.

In block 245, the method may further calculate the Solar NEM Usage (SNU) for the current month from a prior month's balance. As described below, the Solar NEM Usage (SNU) for the current month may be determined by a prior month's balance using Adjustments (in NEM balance) multiplied by the NEM ratio.

The NEM balance is the NEM_{Total} that remains in the beginning of the current month. The NEM_{Total} beginning for the current month may be defined as follows:

$${NEM}_{Total} = \sum {NEM}_{Prior Months} \times NEM Ratio - \sum {SNU}_{Prior Months} .$$

$${NEM}_{Total} = \sum {NEM}_{Prior Mont hs} \times NEM Ratio - ( \sum CMU \times NEM Ratio + \sum EG \times NEM Ratio ) .$$

The SNU_{Current Month}, the user's Solar NEM Usage (SNU) for the current month may be determined by using NEM credits for the current month, NEM_{Current Month}, and by adjusting for SNU and NEM balances from previous months. SNU_{Current Month} may be defined as follows:

$${NEM}_{Current Month} = {NEM}_{Total} - ( {SNU}_{Prior Months} + {SNU}_{Current Month} ) .$$

$${SNU}_{Current Month} = {NEM}_{Total} - {NEM}_{Current Month} - {SNU}_{Prior Months} .$$

In block 250, the method may further include determining the user's self-consumption, that includes battery addition to solar generation and use, solar inverter data, for example, data collected on utility/solar consumption, usage, and generation information by solar inverter device, and a user's Excess Generation (EG) of utility/solar power or the current month's excess generation.

$$Self Consumption ( SC ) = IP - BA - {EG}_{Current Month} .$$

Where IP is defined as the Solar Inverter Production (IP).

In block 255, the method may further include determining an adjustment in year-end credits for any utility company overcharges called “True Up” that credits a user for energy overcharges or overlapping or unpaid utility service acquired by a new tenant from a previous tenant or user account. The True Up may be a proration of service for excess fees or charges by the utility company. The True Up Proration (TU) may be defined as follows:

$$True Up Proration ( TU ) = \frac{NEM Credit “ ( Refund / Charge ) ”}{\% of occupancy period} .$$

In block 260, the method may further include determining the total utility consumption, as an example, total solar consumption, the Total Solar Consumption may be determined as the sum of Total Battery Usage (TBU), SNU usage and NEM credits for the current month, and Self Consumption (SC) as defined in blocks 235-250.

$$Total Solar Consumption ( TS ) = TBU + {( SNU + NEM )}_{Current Month} + SC .$$

In block 265, the method may further calculate the solar rate, the Solar Rate=Market Rate*(1−Discount Rate).

$$Solar Rate ( SR ) = Market Rate \times ( 1 - Discount Rate ) .$$

In block 270, the method may further include determining the total solar bill, the Total Solar Bill. The Total Solar Bill being defined as follows:

$$Total Solar Bill = TS \times SR .$$

### Definitions

A “user”, “landlord”, “customer”, or “consumer” as used herein includes, but is not limited to, any person having installed, financing, paying, or otherwise using a system for generating, monitoring, or reporting usage of one or more utilities.

A “battery”, or “electrical storage system” as used herein includes, but is not limited to, any device for storing electricity.

A “solar panel system”, “generation system”, or “electrical generation system” as used herein includes, but is not limited to, any device or system for generating electricity.

A “utility service”, “utility company”, “utility electric service” as used herein includes, but is not limited to, any type of utility service or utility company service, for example, gas, electricity, water, cable, or internet, and need to be limited to electricity as disclosed herein.

### Computing Device Embodiment

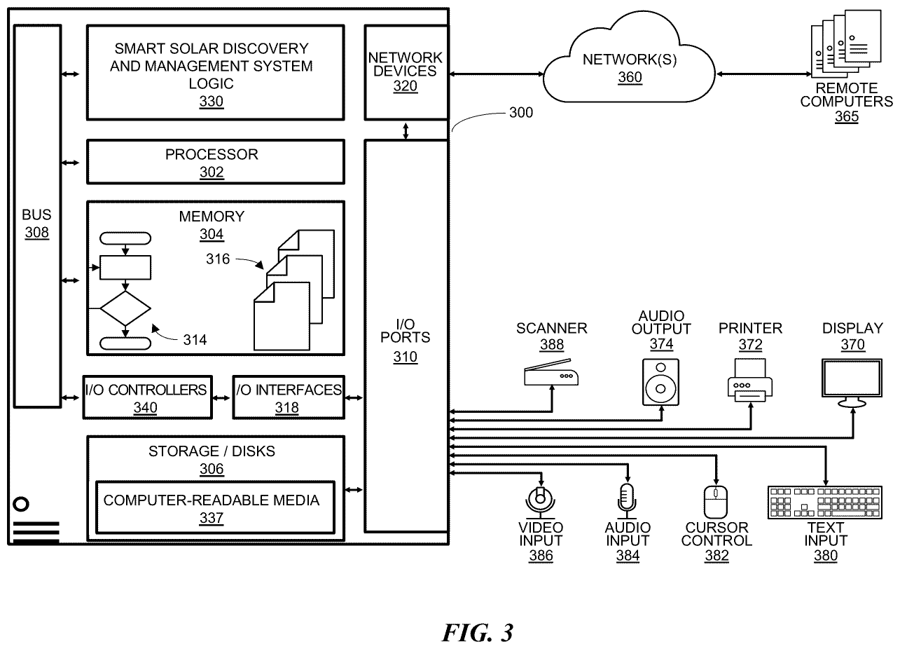

FIG. 3 illustrates an example computing device that is configured and/or programmed as a special purpose computing device with one or more of the example systems and methods described herein, and/or equivalents. The example computing device may be a computer 300 that includes at least one hardware processor 302, a memory 304, and input/output ports 310 operably connected by a bus 308. In one example, the computer 300 may include a smart solar discovery and management system logic 330 configured to collect, report, and/or monitor utility (e.g., electricity and solar power) consumption, generation, and usage data acquired from various sources such as, for example, solar panels, utility company, on premise utility meter, backup power generators, and the like to facilitate portioning, partitioning, and selling of solar generated electricity compliant with state and/or federal rules, laws, or ordinances as the utility collection and monitoring system 100 and associated figures. The mart solar discovery and management system logic 330 may collect and monitor data from various sources that store, deliver, or generate solar power, for example. In different examples, the logic 330 may be implemented in hardware, a non-transitory computer-readable medium 337 with stored instructions, firmware, and/or combinations thereof. While the logic 330 is illustrated as a hardware component attached to the bus 308, it is to be appreciated that in other embodiments, the logic 330 could be implemented in the processor 302, stored in memory 304, or stored in disk 306.

In one embodiment, logic 330 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to facilitate serial or parallel execution of collecting, reporting, and/or monitoring utility (e.g., electricity and solar power) consumption, generation, and usage data acquired from various sources such as, for example, solar panels, utility company, on premise utility meter, backup power generators, and the like. The means may also be implemented as stored computer executable instructions that are presented to computer 300 as data 316 that are temporarily stored in memory 304 and then executed by processor 302.

Logic 330 may also provide means (e.g., hardware, non-transitory computer-readable medium that stores executable instructions, firmware) for performing one or more of the disclosed functions and/or combinations of the functions.

Generally describing an example configuration of the computer 300, the processor 302 may be a variety of various processors including dual microprocessor and other multi-processor architectures. A memory 304 may include volatile memory and/or non-volatile memory. Non-volatile memory may include, for example, ROM, PROM, and so on. Volatile memory may include, for example, RAM, SRAM, DRAM, and so on.

A storage disk 306 may be operably connected to the computer 300 via, for example, an input/output (I/O) interface (e.g., card, device) 318 and an input/output port 310 that are controlled by at least an input/output (I/O) controller 340. The disk 306 may be, for example, a magnetic disk drive, a solid-state disk drive, a floppy disk drive, a tape drive, a Zip drive, a flash memory card, a memory stick, and so on. Furthermore, the disk 306 may be a CD-ROM drive, a CD-R drive, a CD-RW drive, a DVD ROM, and so on. The memory 304 can store a process 314 and/or a data 316, for example. The disk 306 and/or the memory 304 can store an operating system that controls and allocates resources of the computer 300.

The computer 300 may interact with, control, and/or be controlled by input/output (I/O) devices via the input/output (I/O) controller 340, the I/O interfaces 318, and the input/output ports 310. Input/output devices may include, for example, one or more displays 370, printers 372 (such as inkjet, laser, or 3D printers), audio output devices 374 (such as speakers or headphones), text input devices 380 (such as keyboards), cursor control devices 382 for pointing and selection inputs (such as mice, trackballs, touch screens, joysticks, pointing sticks, electronic styluses, electronic pen tablets), audio input devices 384 (such as microphones or external audio players), video input devices 386 (such as video and still cameras, or external video players), image scanners 388, video cards (not shown), disks 306, network devices 320, and so on. The input/output ports 310 may include, for example, serial ports, parallel ports, and USB ports.

The computer 300 can operate in a network environment and thus may be connected to the network devices 320 via the I/O interfaces 318, and/or the 1/O ports 310. Through the network devices 320, the computer 300 may interact with a network 360. Through the network, the computer 300 may be logically connected to remote computers 365. Networks with which the computer 300 may interact include, but are not limited to, a LAN, a WAN, and other networks.

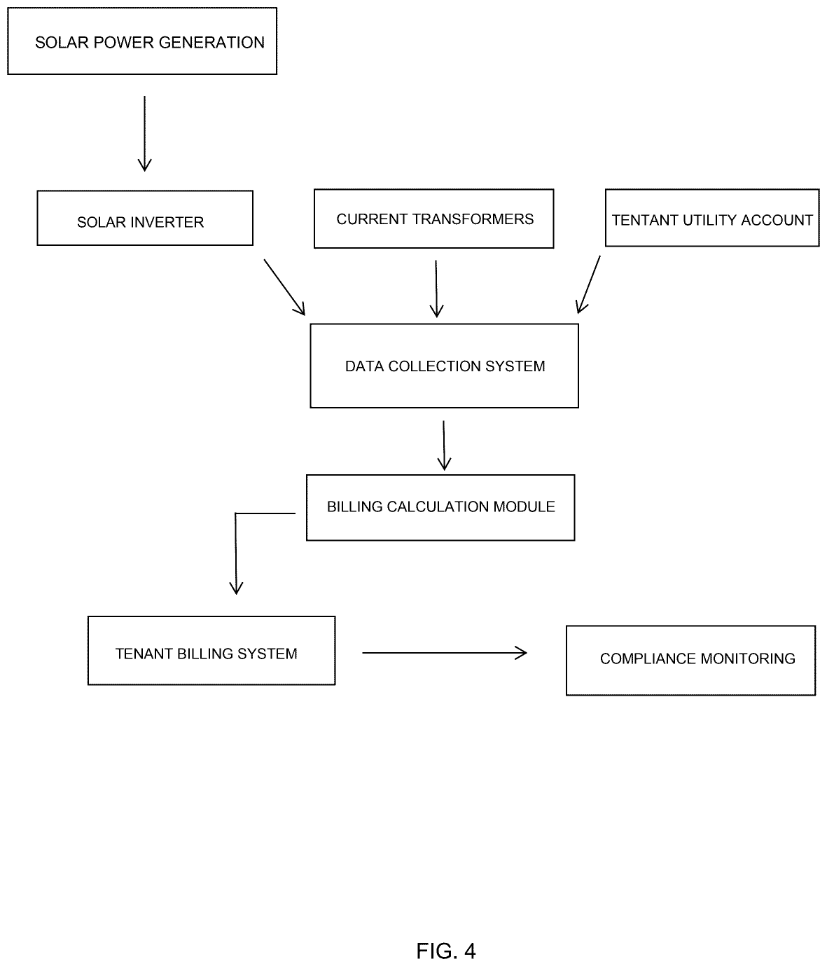

Referring to FIG. 4, one embodiment of the system provides a landlord-tenant solar billing functionality that ensures tenants are accurately billed for their actual solar energy consumption. This is accomplished through data collection, usage calculation, and billing determination.

In one embodiment, for data collection, the data collection module 400 gathers data from the solar inverter 110, the tenant's utility account, and any optional real-time monitoring devices (e.g., CTs).

In one embodiment, for usage calculation, the system determines how much the generated solar power was directly consumed by the tenant.

In one embodiment, for billing determination, the tenants bill is calculated using the formula: Tenant Bill=(Solar Usage×Discount Rate). Where the discount rate is predefined by the landlord but constrained to ensure compliance with local regulations. Compliance monitoring enables the system to automatically verify that the tenant's bill does not exceed what they would have paid if purchasing the same amount of electricity from the grid. Simplifying solar energy monetization for landlords while ensuring tenants receive fair and transparent billing.

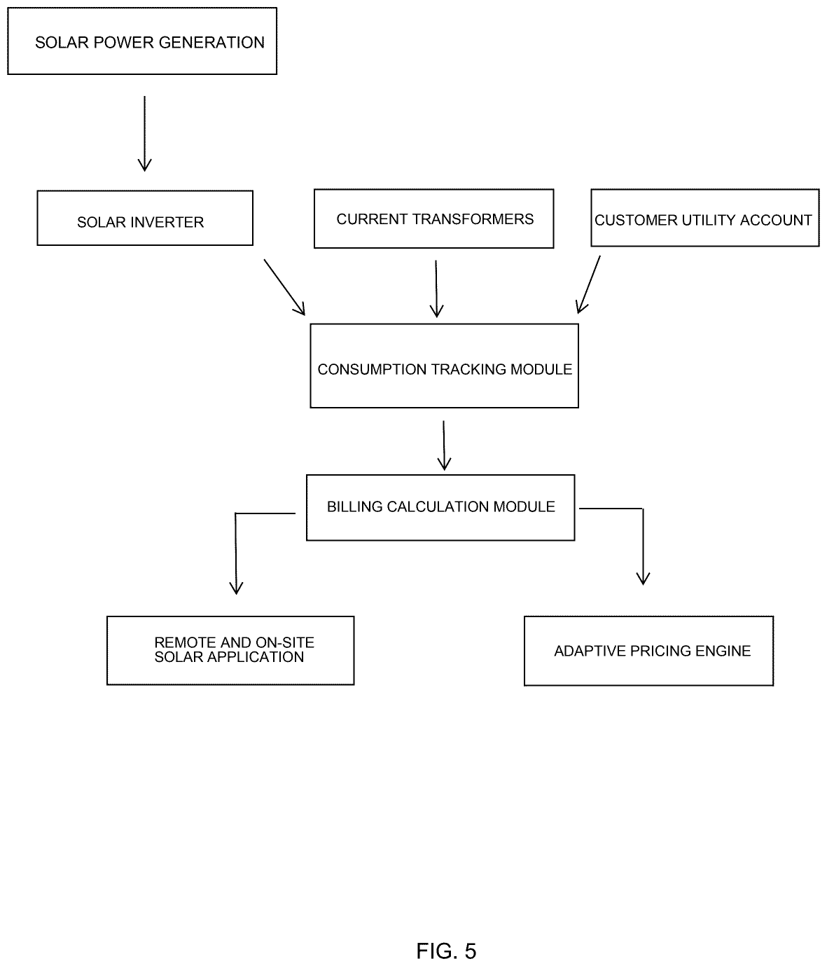

Referring to FIG. 5, the system introduces a usage-based power purchase agreement that charges customers based on their actual solar energy consumption rather than production. Unlike traditional PPAs, which bill customers based on total system generation. This model ensures, precise consumption tracking, billing flexibility, remote and on-site application, and an adaptive pricing model.

In one embodiment for precise consumption tracking, the system integrates inverter production data, utility account readings, and optional real-time monitoring data to determine the actual energy consumption.

In one embodiment for billing flexibility, the PPA is structured to charge customers at a dynamic rate based on actual solar usage, preventing overbilling when consumption is lower than the system production.

In one embodiment for remote and onsite application, the system applies to on-site solar installations as well as community renewable energy facilities (CREFs), where power is generated remotely but allocated to individual users based on real consumption data.

In one embodiment for adaptive pricing, the structure dynamically adjusts based on market rates, ensuring fair pricing for both consumers and solar providers.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element, or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discreet logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A computer-implemented method, the method comprising:
acquiring a discount rate for a utility electric service;
determining a market rate based on a tier of the utility electric service;
calculating a net energy metering (NEM) credit, the NEM credit being determined based on the excess electricity produced;
determining at least one of an electrical generation system or an electrical storage system;
calculating electricity generated from the electrical generation system or the electrical storage system;
generating and displaying, via a graphical user interface (GUI), the NEM credit, calculated actual solar usage, and the electricity generated for a predetermined period;
determining solar energy usage by comparing inverter production data with real-time utility account or on-premise meter data;
computing tenant-specific solar usage in a multi-tenant property to enable per-user solar billing; and
applying a predefined discount rate to determine a tenant's solar bill based on actual consumption.

2. The method of claim 1, further comprising determining the electricity generated by calculating the electricity added to the electrical storage system, and further calculating daily electricity added to the electrical storage system during a predetermined period.

3. The method of claim 2, further comprising calculating the total electricity usage from the electrical storage system as the sum of daily subtractions from the electrical storage system in a given month.

4. The method of claim 1, further comprising comparing the electricity generated with electricity consumption for a predetermined period to obtain a net electricity usage, wherein net electricity usage includes individual user consumption tracking in shared solar systems for allocation of solar energy in multi-user environments.

5. The method of claim 4, further comprising calculating the (NEM) credit from at least one of the electricity generated, the electricity consumed, or the net electricity usage.

6. The method of claim 4, further comprising calculating a solar NEM usage (SNU) for a current period based on the balance of SNU from a prior period, wherein the solar NEM usage (SNU) is usage of solar generated electricity that has been allocated dynamically to individual tenants or customers based on their specific energy consumption patterns.

7. The method of claim 1, further comprising determining the NEM credit and the electricity generated for a predetermined period by accessing data from a solar inverter, wherein the solar inverter in communicably coupled to at least the utility electric service and the electrical generation system, and further integrating usage data from real-time monitoring devices such as current transformers.

8. A non-transitory computer-readable medium that includes stored thereon computer-executable instructions that when executed by at least a processor of a computer cause the computer to:
acquire a discount rate for a utility electric service;
determine a market rate based on a tier of the utility electric service;
calculate a net energy metering (NEM) credit, the NEM credit being determined based on the excess electricity produced;
determine at least one of an electrical generation system or an electrical storage system;
calculate electricity generated from the electrical generation system or the electrical storage system; and
generate and display, via a graphical user interface (GUI), the NEM credit and the electricity generated for a predetermined period.

9. The non-transitory computer-readable medium of claim 8, further comprising instructions that when executed by at least the processor cause the processor to:
determine the electricity generated by calculating the electricity added to the electrical storage system, and further calculate daily electricity added to the electrical storage system during a predetermined period.

10. The non-transitory computer-readable medium of claim 9, further comprising instructions that when executed by at least the processor cause the processor to:
calculate the total electricity usage from the electrical storage system as the sum of daily subtractions from the electrical storage system in a given month.

11. The non-transitory computer-readable medium of claim 8, further comprising instructions that when executed by at least the processor cause the processor to:
compare the electricity generated with electricity consumption for a predetermined period to obtain a net electricity usage.

12. The non-transitory computer-readable medium of claim 11, further comprising instructions that when executed by at least the processor cause the processor to:
calculate the (NEM) credit from at least one of the electricity generated, the electricity consumed, or the net electricity usage.

13. The non-transitory computer-readable medium of claim 11, further comprising instructions that when executed by at least the processor cause the processor to:
calculate a solar NEM usage (SNU) for a current period based on the balance of SNU from a prior period, wherein the solar NEM usage (SNU) is usage of solar generated electricity.

14. The non-transitory computer-readable medium of claim 8, further comprising instructions that when executed by at least the processor cause the processor to:
determine the NEM credit and the electricity generated for a predetermined period by accessing data from a solar inverter, wherein the solar inverter in communicably coupled to at least the utility electric service and the electrical generation system.

15. A computing system, comprising:
at least one processor connected to at least one memory;
a non-transitory computer readable medium including instructions stored thereon that when executed by at least the processor cause the processor to:
acquire a discount rate for a utility electric service;
determine a market rate based on a tier of the utility electric service;
calculate a net energy metering (NEM) credit, the NEM credit being determined based on the excess electricity produced;
determine at least one of an electrical generation system or an electrical storage system;
calculate electricity generated from the electrical generation system or the electrical storage system;
calculate solar energy usage by analyzing inverter production data, real-time consumption data, and net metering credits used within a given period;
compute individual tenant or customer usage in a multi-unit environment and apply a dynamic discount rate for billing; and
generate and display, via a graphical user interface (GUI), the NEM credit, solar usage breakdown, and billing based on actual consumption.

16. The computing system of claim 15, wherein the instructions further include instructions that when executed by at least the processor cause the processor to:
determine the electricity generated by calculating the electricity added to the electrical storage system, and further calculate daily electricity added to the electrical storage system during a predetermined period.

17. The computing system of claim 16, wherein the instructions further include instructions that when executed by at least the processor cause the processor to:
calculate the total electricity usage from the electrical storage system as the sum of daily subtractions from the electrical storage system in a given month.

18. The computing system of claim 15, wherein the instructions further include instructions that when executed by at least the processor cause the processor to:
compare the electricity generated with electricity consumption for a predetermined period to obtain a net electricity usage.

19. The computing system of claim 17, wherein the instructions further include instructions that when executed by at least the processor cause the processor to:
calculate the (NEM) credit from at least one of the electricity generated, the electricity consumed, or the net electricity usage.

20. The computing system of claim 17, wherein the instructions further include instructions that when executed by at least the processor cause the processor to:
calculate a solar NEM usage (SNU) for a current period based on the balance of SNU from a prior period, wherein the solar NEM usage (SNU) is usage of solar generated electricity.
